(19) United States
(12) Patent Application Publication
(10) Pub. No.: US 2024/0291129 A1
(43) Pub. Date: Aug. 29, 2024

(54) LUMPED CENTER CONDUCTOR ASSEMBLY

(71) Applicant: ZHEJIANG DONGYANG DONGCI CHENGJI ELECTRONICS CO. , LTD., Jinhua (CN)

(72) Inventors: Juanjuan ZHANG, Jinhua (CN); Xiaodan SUN, Jinhua (CN)

(21) Appl. No.: 18/573,516

(22) PCT Filed: Sep. 6, 2021
(86) PCT No.: PCT/CN2021/116653

§ 371 Date: Dec. 22, 2023

(30) Foreign Application Priority Data
Jun. 22, 2021 (CN) 202121394326.9

(51) Int. Cl. H01P 1/32

(52) U.S. Cl. CPC H01P 1/32

(57) ABSTRACT

Disclosed is a lumped center conductor assembly comprising a center conductor main body. A gyromagnetic sheet is provided on the center conductor main body; the center conductor main body and the gyromagnetic sheet are both a polygonal structure symmetrical along a central axis thereof; and there are three conductor legs in an annular array on sides of the center conductor main body. According to the present invention, the three conductor legs are bent twice to naturally form required included angles, without the need of using a complex and high-cost tooling fixture for correction. According to the present invention, the three conductor legs are vertically bent upwards and are in close contact with side walls of the gyromagnetic sheet, thereby solving the problem of insufficient contact between the conductor legs and the side surface of the gyromagnetic sheet.

### CROSS-REFERENCE TO RELATED APPLICATIONS

This application is a U.S. national phase application of a PCT Application No. PCT/CN2021/116653 filed on Sep. 6, 2021, which claims a priority to Chinese Patent Application No. 202121394326.9 filed on Jun. 22, 2021, the disclosures of which are incorporated in their entirety by reference herein.

### FIELD OF THE INVENTION

The present invention belongs to the technical field of center conductors, and specifically relates to a lumped center conductor assembly.

### BACKGROUND OF THE INVENTION

With the rapid development of the information age, high-frequency communication devices such as mobile phones and communication base stations have become people's demand. Moreover, with the application of 5G technology, the demand is growing exponentially, and the requirement for assembly time and flexibility of products is becoming increasingly high. The existing technology can no longer meet the growing demand.

The center conductor assemblies currently used in small high-frequency isolators and circulators are mostly round and square. A round gyromagnetic sheet is not easy to be assembled automatically; and the side of the center conductor leg is not in sufficient contact with the gyromagnetic sheet, which tends to cause a large gap, with a consequent inhibition of improvement in the characteristics of the isolator or circulator.

In addition, in the case of a square or round gyromagnetic sheet, the center conductor needs to cross the side wall of the gyromagnetic sheet to be located on top of the gyromagnetic sheet when bent during the production and assembly, so it is not possible to naturally form required included angles. As a result, a complex tooling fixture is required for correction, which is costly, making the production complex and difficult.

### SUMMARY OF THE INVENTION

In order to solve the problems raised in the above “background of the invention”, the present invention provides a lumped center conductor assembly, which has the characteristics of easy automated assembly and sufficient contact of the center conductor leg with the side of the gyromagnetic sheet.

In order to achieve the above object, the present invention provides the following technical solution: A lumped center conductor assembly is provided, comprising a center conductor main body; a gyromagnetic sheet is provided on the center conductor main body; the center conductor main body and the gyromagnetic sheet are both a polygonal structure symmetrical along a central axis thereof; and there are three conductor legs in an annular array on sides of the center conductor main body.

In order to facilitate automated assembly, further, a contour of the center conductor main body is of a same size as a contour of the gyromagnetic sheet, and the sides of the center conductor main body are aligned with sides of the gyromagnetic sheet.

In order to naturally form required included angles, no complex and high-cost tooling fixture is used for correction. Further, the three conductor legs are vertically bent upwards at their connections with the center conductor main body and are in contact with side walls of the gyromagnetic sheet, and portions of the three conductor legs above the gyromagnetic sheet are bent horizontally in turn.

In order to facilitate contact and connection with elements under the center conductor assembly, further, a pin is connected to an end of each of the conductor legs, and the pins are vertically bent downwards at their connections with the conductor legs and then horizontally bent outwards.

In order to flexibly adjust the amount of inductance, further, each of the conductor legs is provided in the middle thereof with a through slot.

In order to achieve an insulating effect, further, the lumped center conductor assembly also includes a plurality of separators, which are arranged between a bottom conductor leg and a middle conductor leg, between the middle conductor leg and a top conductor leg, and above the top conductor leg, respectively, after the three conductor legs are bent twice.

Further, the center conductor main body and the gyromagnetic sheet are both a regular hexagonal structure.

Further, the center conductor main body and the gyromagnetic sheet are both a hexagonal structure with spaced edges of equal length.

The present invention has the following beneficial effects compared to the prior art:
a. According to the present invention, the center conductor main body and the gyromagnetic sheet are both a polygonal structure symmetrical along the central axis thereof, and there are three conductor legs in an annular array on sides of the center conductor main body; and the three conductor legs are bent twice to naturally form required included angles, without the need of using a complex and high-cost tooling fixture for correction.
b. According to the present invention, the three conductor legs are vertically bent upwards and are in close contact with side walls of the gyromagnetic sheet, thereby solving the problem of insufficient contact between the conductor legs and the side surface of the gyromagnetic sheet.

### BRIEF DESCRIPTION OF THE DRAWINGS

The accompanying drawings are used to provide a further understanding of the present invention, and form a part of the description. They are used in conjunction with examples of the present invention to explain the present invention, but do not constitute a limitation on the present invention. In the drawings:

FIG. 1 is an exploded schematic diagram of the structure of the present invention before assembly;

FIG. 2 is a schematic diagram of the structure of the center conductor main body and the gyromagnetic sheet of the present invention after assembly;

FIG. 3 is a schematic diagram of the structure of the present invention after assembly;

FIG. 4 is an exploded schematic diagram of the structure of Example 2 of the present invention before assembly;

FIG. 5 is a schematic diagram of the structure of the center conductor main body and the gyromagnetic sheet of Example 2 of the present invention after assembly; and

FIG. 6 is a schematic diagram of the structure of Example 2 of the present invention after assembly;

where: 1. center conductor main body; 2. gyromagnetic sheet; 3. separator; 4. conductor leg; 5. through slot; and 6. pin.

### DETAILED DESCRIPTION OF THE EMBODIMENTS

The technical solution in the examples of the present invention will be described clearly and completely in the following in combination with the drawings in the examples of the present invention. Obviously, these examples are only some, rather than all, of the examples of the present invention. All the other examples obtained by those of ordinary skill in the art based on the examples of the present invention without creative efforts shall fall within the scope of protection of the present invention.

### Example 1

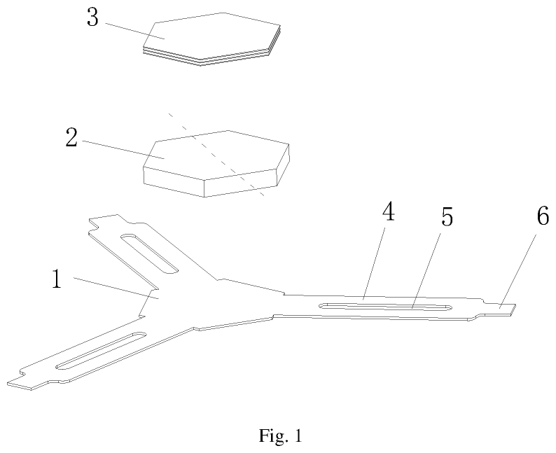

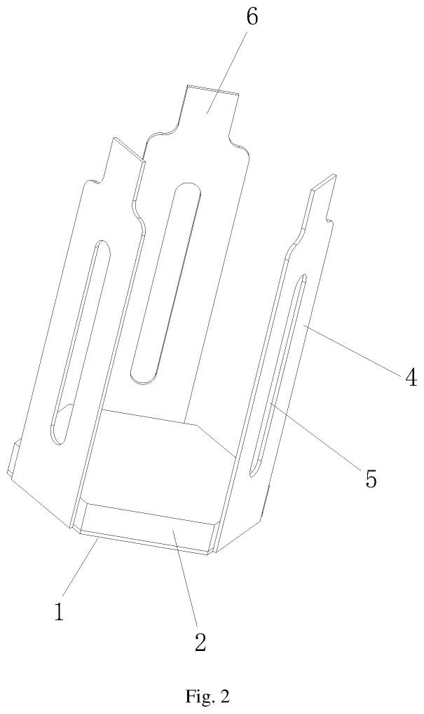

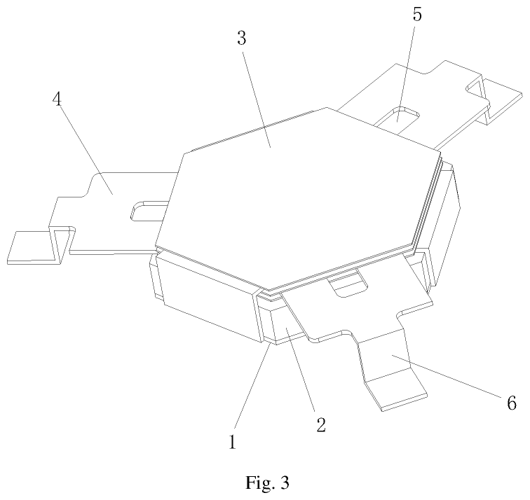

As shown in FIGS. 1-3, the present invention provides the following technical solution: A lumped center conductor assembly is provided, comprising a center conductor main body 1; a gyromagnetic sheet 2 is provided on the center conductor main body 1; a contour of the center conductor main body 1 is of a same size as a contour of the gyromagnetic sheet 2, and the sides of the center conductor main body 1 are aligned with sides of the gyromagnetic sheet 2; the center conductor main body 1 and the gyromagnetic sheet 2 are both a regular hexagonal structure; and there are three conductor legs 4 in an annular array on sides of the center conductor main body 1.

Specifically, the three conductor legs 4 are vertically bent upwards at their connections with the center conductor main body 1 and are in contact with side walls of the gyromagnetic sheet 2, and portions of the three conductor legs 4 above the gyromagnetic sheet 2 are bent horizontally in turn.

With the above technical solution, the three conductor legs 4 are bent twice to naturally form included angles of 120°, without the need of using a complex and high-cost tooling fixture for correction. In addition, the three conductor legs 4 are vertically bent upwards and are in close contact with side walls of the gyromagnetic sheet 2, thereby solving the problem of insufficient contact between the conductor legs 4 and the side surface of the gyromagnetic sheet 2.

Specifically, there are pins 6 at the ends of the conductor legs 4, and the pins 6 are vertically bent downwards at their connections with the conductor legs 4 and then horizontally bent outwards.

With the above technical solution, after the pins 6 have been bent twice, the ends of the pins 6 are in the same plane as the bottom surface of the center conductor assembly, making the pins 6 easy to contact and connect with the elements under the center conductor assembly.

Specifically, each of the conductor legs 4 is provided in the middle thereof with a through slot 5.

With the above technical solution, by adjusting the width of the through slots 5, the width of the conductor legs 4 can be adjusted to flexibly adjust the amount of inductance.

Specifically, the lumped center conductor assembly also includes three separators 3, which are arranged between a bottom conductor leg and a middle conductor leg, between the middle conductor leg and a top conductor leg, and above the top conductor leg, respectively, after the three conductor legs are bent twice. The separators 3 are also a regular hexagonal structure, and are of the same size as the center conductor main body 1.

With the above technical solution, the separator between the bottom conductor leg and the middle conductor leg and the separator between the middle conductor leg and the top conductor leg provide an insulating effect, and the separator 3 above the top conductor leg prevents the conductor leg from springing back.

### Example 2

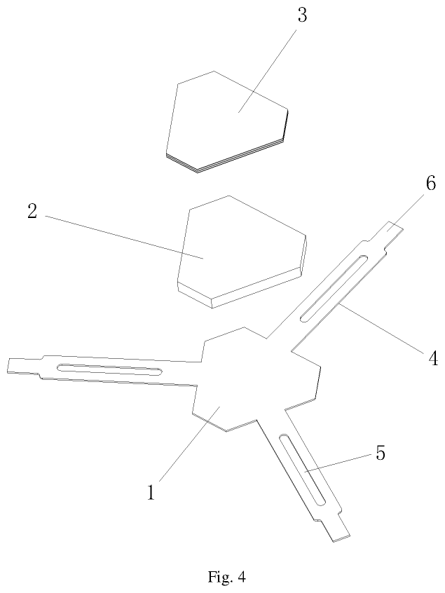

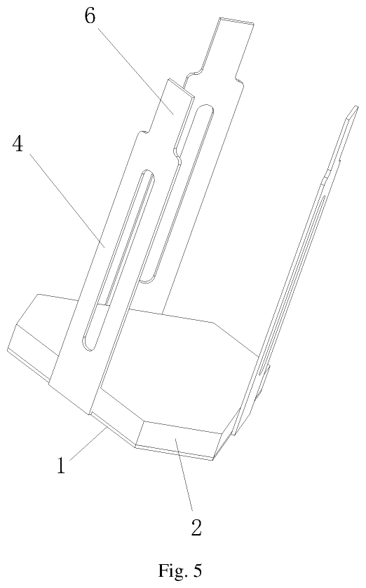

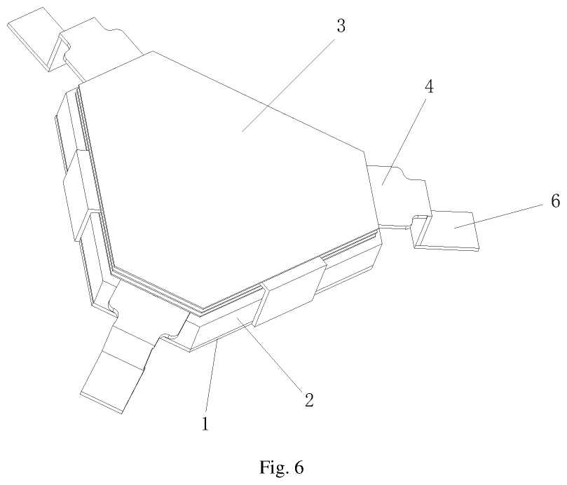

As shown in FIGS. 4-6, this example is distinguished from Example 1 in that, specifically, the center conductor main body 1 and the gyromagnetic sheet 2 are both a hexagonal structure with spaced edges of equal length.

With the above technical solution, this example indicates that the shapes of the center conductor main body 1 and the gyromagnetic sheet 2 include, but are not limited to, a regular hexagon or a hexagon with spaced edges of equal length, or other eligible polygons; and the shapes of the center conductor main body 1 and the gyromagnetic sheet 2 can be designed according to the requirement for the angle between the conductor legs.

To sum up, according to the present invention, the center conductor main body 1 and the gyromagnetic sheet 2 are both a polygonal structure symmetrical along the central axis thereof, and there are three conductor legs 4 in an annular array on sides of the center conductor main body 1; and the three conductor legs 4 are bent twice to naturally form required included angles, without the need of using a complex and high-cost tooling fixture for correction. According to the present invention, the three conductor legs 4 are vertically bent upwards and are in close contact with side walls of the gyromagnetic sheet 2, thereby solving the problem of insufficient contact between the conductor legs 4 and the side surface of the gyromagnetic sheet 2.

Finally, it should be noted that the above are only preferred examples of the present invention, and are not intended to limit the present invention; although the present invention has been described in detail with reference to the foregoing examples, those skilled in the art can still modify the technical solutions in the foregoing examples, or equivalently replace some of the technical features therein; and any modification, equivalent replacement, improvement and the like made within the spirit and principle of the present invention shall be included within the scope of protection of the present invention.

1. A lumped center conductor assembly, comprising a center conductor main body, characterized in that: a gyromagnetic sheet is provided on the center conductor main body; the center conductor main body and the gyromagnetic sheet are both a polygonal structure symmetrical along a central axis thereof; and there are three conductor legs in an annular array on sides of the center conductor main body.

2. The lumped center conductor assembly according to claim 1, characterized in that: a contour of the center conductor main body is of a same size as a contour of the gyromagnetic sheet, and the sides of the center conductor main body are aligned with sides of the gyromagnetic sheet.

3. The lumped center conductor assembly according to claim 1, characterized in that: the three conductor legs are vertically bent upwards at their connections with the center conductor main body and are in contact with side walls of the gyromagnetic sheet, and portions of the three conductor legs above the gyromagnetic sheet are bent horizontally in turn.

4. The lumped center conductor assembly according to claim 1, characterized in that: a pin is connected to an end of each of the conductor legs.

5. The lumped center conductor assembly according to claim 4, characterized in that: the pins are vertically bent downwards at their connections with the conductor legs, and then horizontally bent outwards.

6. The lumped center conductor assembly according to claim 1, characterized in that: each of the conductor legs is provided in the middle thereof with a through slot.

7. The lumped center conductor assembly according to claim 3, characterized in that: the assembly further comprises a plurality of separators, which are arranged between a bottom conductor leg and a middle conductor leg, between the middle conductor leg and a top conductor leg, and above the top conductor leg, respectively, after the three conductor legs are bent twice.

8. The lumped center conductor assembly according to claim 1, characterized in that: the center conductor main body and the gyromagnetic sheet are both a regular hexagonal structure.

9. The lumped center conductor assembly according to claim 1, characterized in that: the center conductor main body and the gyromagnetic sheet are both a hexagonal structure with spaced edges of equal length.
